(19) United States
(12) Patent Application Publication
(10) Pub. No.: US 2010/0173120 A1
(43) Pub. Date: Jul. 8, 2010

(54) Carpet Tile Having Antimicrobial Properties and Method of Manufacturing the Same

(75) Inventor: Shawn David McGill, Dalton, GA (US)

Correspondence Address: SUTHERLAND ASBILL & BRENNAN LLP, 999 PEACHTREE STREET, N.E., ATLANTA, GA, 30309, US

(73) Assignee: Beaulieu Group, LLC, Dalton, GA (US)

(21) Appl. No.: 12/684,240

(22) Filed: Jan. 8, 2010

Related U.S. Application Data
(60) Provisional application No. 61/143,198, filed on Jan. 8, 2009.

(51) Int. Cl. D05C 17/02; D05C 17/00; B32B 38/08

(52) U.S. Cl. 428/95; 428/85; 156/278

(57) ABSTRACT

Carpet products having antimicrobial properties and methods of manufacturing the same are provided. The carpet product includes a face fabric having a top surface and a base, and a pre-treated stabilizing material attached to the base of the face fabric. The pre-treated stabilizing material may have an antimicrobial compound coated thereonto or physically incorporated.

### CROSS REFERENCE TO RELATED APPLICATIONS

This application claims priority under 35 U.S.C. §119(e) to U.S. Provisional Patent Application Ser. No. 61/143,198 filed on Jan. 8, 2009, which is incorporated herein by reference in its entirety.

### STATEMENT REGARDING FEDERALLY SPONSORED RESEARCH OR DEVELOPMENT

Not applicable.

### BACKGROUND OF THE INVENTION

The present invention relates generally to the field of carpets and carpet tiles, and more particularly to carpets and carpet tiles having antimicrobial properties.

Carpet tiles are modular floor coverings having a textile top surface which are arranged and installed on various types of floor surfaces. FIG. 1 is a cross-section view, illustrating a common “tufted” configuration of a carpet tile. The carpet tile 10 includes a plurality of tufts 16 created by sewing a yarn through the primary carpet base 18 to form a fabric face 12. The fabric face 12 is attached to a backing 14 by an adhesive 20. The backing 14 includes fiberglass scrim 22, which are a commonly used stabilizing material for carpet tiles. Various other carpet tile configurations are known.

Carpet tiles are typically cut from a larger broadloom floor covering that is produced from a conventional broadloom manufacturing process. Generally, this involves a first process in which the fabric face 12 is produced by tufting or fusion bonding; a second process in which the backing 14 is produced, such as by a weaving or extrusion process; a third lamination process in which the fabric face 12 is laminated to the backing 14 with the adhesive 20; and a curing process in which the broadloom is fed through an oven or other device to dry and/or cure the adhesive 20. The broadloom is then cooled and cut into individual carpet tiles.

The fiberglass scrim 22 or other stabilizing materials are integrated into the backing polymer most commonly by an extrusion process or a direct lamination process. The stabilizing material provides dimensional stability to the carpet tile 10 and prevents growth or shrinkage due to the wide variety of temperature and humidity conditions to which the tiles may be exposed. The stabilizing material may be arranged in regular or irregular patterns in the backing. The backing polymer typically comprises polyvinyl chlorides (PVC), polyethylenes, modified polypropylenes, ethyl vinyl acetates, modified PET or blends thereof.

It has become increasingly common to treat carpet tiles with antimicrobial chemicals to impart antimicrobial properties to the tile. This has typically been achieved by adding the antimicrobial chemicals to the carpet tile backing polymer, i.e., the material into which the fiberglass scrim 22 is extruded, woven, or laminated. These chemicals impart antimicrobial protection to the carpet tile backing by blocking any microbial growth at the intersection of the backing 14 of the carpet tile 10 and the floor of the building in which the carpet tile is eventually installed.

A relatively large amount of antimicrobial compound per unit of covered area is required when treating carpet tiles by such conventional methods. The backing polymer typically has a weight of about 30 to about 130 ounces per square yard. Because the entire polymer is treated as part of a batch process, a sufficient quantity of antimicrobial compound must be provided to account for the depth of the polymer while providing uniform distribution of the antimicrobial compound. It therefore would be desirable to reduce the amount of antimicrobial compound needed per unit area of carpet without diminishing the antimicrobial characteristics of the carpet tile.

### BRIEF SUMMARY OF THE INVENTION

In one aspect, a carpet product having antimicrobial properties is provided. The carpet product comprises a face fabric having a top surface and a base, and a pre-treated stabilizing material attached to the base of the face fabric. The pre-treated stabilizing material may have an antimicrobial compound coated thereonto or physically incorporated.

In another aspect, a carpet product is provided which comprises a primary carpet base having a fabric face side and an opposed back side. The carpet product may further comprise a polymer backing layer attached to the back side of the primary carpet base, and a layer of a pre-treated stabilizing material laminated or otherwise attached to the polymer backing layer. The pre-treated stabilizing material may have an antimicrobial compound coated thereonto.

In another aspect, a method of manufacturing a carpet product is provided. The method may comprise applying an antimicrobial compound to a stabilizing material to produce a pre-treated stabilizing material that exhibits antimicrobial properties, and attaching the pre-treated stabilizing material to the base of a face fabric.

### BRIEF DESCRIPTION OF THE DRAWINGS

FIG. 1 is a cross-section view, illustrating a tufted configuration of a carpet tile.

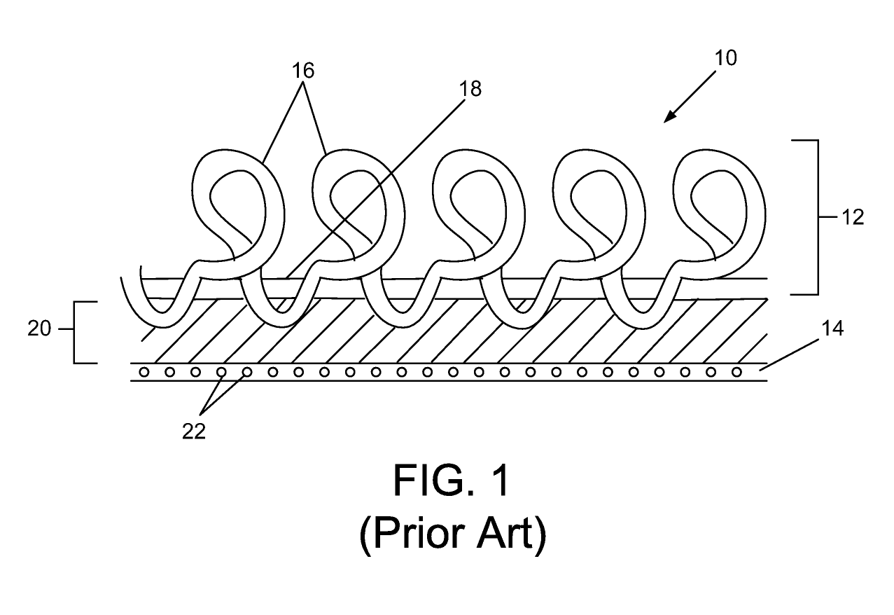

FIG. 2 is a cross-section view, illustrating a tufted configuration of a carpet tile produced in accordance with one or more embodiments of the present invention.

### DETAILED DESCRIPTION OF THE INVENTION

An improved carpet product, such as a carpet tile, having antimicrobial properties has been developed, along with a new method of manufacturing the antimicrobial carpet tile. The carpet product includes structural, stabilizing materials that have been pretreated with antimicrobial compounds before the stabilizing materials are combined with the polymer backing. The antimicrobial compound attaches directly to the stabilizing material.

Because the stabilizing material may be provided in a substantially uniform manner across the bottom of the carpet tile, a substantially uniform distribution of the antimicrobial compounds may be achieved. Since the stabilizing materials comprise a smaller percentage of the entire weight of the backing composite (the stabilizing materials typically have weight ranges between about 2 and about 50 ounces per square yard), a smaller quantity of antimicrobial compound is required to treat the carpet tile than in the conventional, polymer-treating methods. That is, the antimicrobial compound is strategically located where it is needed in the carpet tile structure (i.e., at or near the bottom surface of the carpet tile) and not “wasted” throughout the entire thickness of the polymer backing layer.

### Carpet Products

In one aspect, carpet products having antimicrobial properties are provided. The carpet product may comprise a face fabric having a top surface and a base, and a pre-treated stabilizing material attached to the base of the face fabric. The pre-treated stabilizing material may have an antimicrobial compound coated thereonto or physically incorporated therein. The pre-treated stabilizing material may be affixed to the fabric face by a polymer backing layer. In a preferred embodiment, the polymer backing layer comprises substantially no antimicrobial compound additive.

In one embodiment, the carpet product comprises a primary carpet base having a fabric face side and an opposed back side. The carpet product may further comprise a polymer backing layer attached to the back side of the primary carpet base, and a layer of a pre-treated stabilizing material laminated or otherwise attached to the polymer backing layer. The pre-treated stabilizing material may have an antimicrobial compound coated thereonto or physically incorporated therein. In certain embodiments, the polymer backing layer may be substantially devoid of any antimicrobial compound additives.

In some embodiments, the antimicrobial compound comprises zinc pyrithione. In some embodiments, the pre-treated stabilizing material comprises a fiberglass scrim, a non-woven PET, polyamide, polypropylene, polyester or a blend thereof. The carpet product may comprise about 0.5 grams to about 50 grams, or more preferably about 0.5 grams to about 10 grams of solid antimicrobial compound per square yard. In some embodiments, the carpet product comprises about 2 to about 3 grams of solid antimicrobial compound per square yard. In preferred embodiments, the carpet product includes antimicrobial compounds in types and amounts for the carpet product to exhibit antimicrobial properties sufficient to pass AATCC Test Method 174.

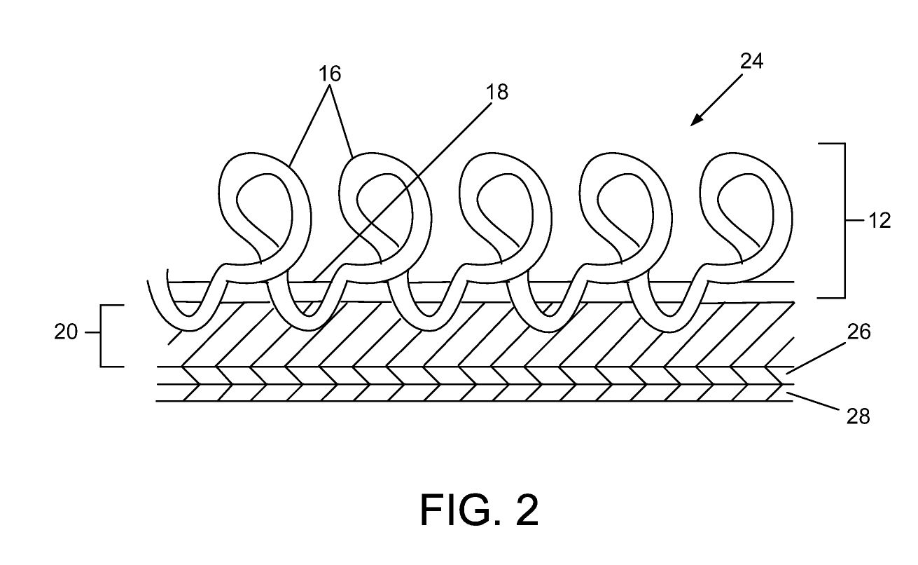

FIG. 2 is a cross-sectional view illustrating one exemplary embodiment of the present antimicrobial carpet tile. The carpet tile 24 includes a plurality of tufts 16 created by sewing a yarn through the primary carpet base 18 to form a fabric face 12. The face fabric 12 may be essentially any suitable material and construction known in the art. The fabric face 12 may be attached to a polymer backing 26 by an adhesive 20. In some embodiments, the polymer backing 26 and the adhesive 20 may be combined into a single layer. For example, the polymer backing 26 may also serve as an adhesive to maintain the tufting of the fabric face 12 (i.e., hold the yarn in the primary carpet base 18). A layer of stabilizing material 28 is attached beneath the polymer backing 26. The stabilizing material 28 may be treated with an antimicrobial compound before attachment (e.g., lamination) to the polymer backing. As such, the antimicrobial compound is provided at the tile-floor interface.

The fabric face of the carpet tiles can be of any type, including cut pile, loop pile, cut and loop pile, tufted, bonded, woven, nonwoven, or the like.

The antimicrobial carpet tiles may be of any desired area dimension; however, a preferred shape is that of a square tile. Particularly preferred are tiles which are either 18″ by 18″, 24″ by 24″, 36″ by 36″, 50 cm by 50 cm, or 1 m by 1 m. Tiles having different dimensions and shapes are also contemplated. The carpet tiles also may be of any desired thickness. For example, the carpet tiles may have an overall thickness from about 0.15″ to about 0.75″.

The terms “antimicrobial compound” or “antimicrobial agent” as used herein are intended to encompass any compound that exhibits sufficient antimicrobial activity and is suitable for use in a carpet tile product. Various antimicrobial compounds may be used to treat the stabilizing material 28 including organic antimicrobial agents, silver-containing resins, silver-containing zeolites, silver-containing glass, silver-based ion exchange compounds, triclosan, inorganic antimicrobial materials, metal based zeolites, metal salts, metal oxides, metal hydroxides, transition metal ions, zinc oxide, pyrithione and derivatives, zinc pyrithione, tributyl tin oxide derivatives, 3-iodo-2-propylbutyl carbamate, n-butyl-1,2 benziso thiazoline, 10,10′-oxybisphenoxiarsine, and sodium o-phenylphenate, aminoglycosides, ansamacrolides, beta-lactams, lincosaminides, macrolides, nitrofurans, nucleosides, oligosaccharides, peptides, polypeptides, phenazines, polyenes, polyethers, quilones, tetracyclines, sulfonamides, and quaternary compounds, including silane quaternary compounds.

In a preferred embodiment, the antimicrobial compound is zinc pyrithione. It may be applied to the stabilizing material as an aqueous fine particle dispersion, which is commercially available, for example, as Zinc OMADINE™ (Arch Chemicals Inc.). In one embodiment, the antimicrobial compound is of a type and present in the carpet tile in an amount effective to pass the American Association of Textile Chemists and Colorists (AATCC) Test Method 174 for antimicrobial activity. The effective amount of antimicrobial needed depends entirely on the material being tested and the stability or durability of the compound. With Zinc OMADINE™, about 0.5 grams to about 50 grams of solid material per square yard has been found to impart sufficient microbial resistance to pass the AATCC test protocol. The amount of antimicrobial compound required may vary significantly depending upon the type of antimicrobial compound selected and the application technique used. For example, a different amount of Zinc OMADINE™ may be required if the antimicrobial compound is applied by spraying an aqueous solution or suspension containing the compound onto the stabilizing material.

The term “stabilizing material” as used herein is intended to encompass essentially any suitable material known in the art for imparting dimensional stability to a carpet tile and/or for reducing growth/shrinkage of the carpet tile when the carpet tile is exposed to variations in temperature and humidity. Representative examples of materials that may be employed as the stabilizing material for the carpet tile described herein include, but are not limited to, woven and non-woven fiberglass scrims and scrims of other natural or synthetic fibers; non-woven fabrics, such as non-woven polyethylene teraphthalate (PET), polyamides, polypropylene, polyester, or blends thereof; and combinations thereof.

### Methods of Manufacture

In another aspect, methods of manufacturing a carpet product, such as a carpet tile, having antimicrobial properties are provided. The method may comprise applying an antimicrobial compound to a stabilizing material to produce a pre-treated stabilizing material that exhibits antimicrobial properties, and attaching the pre-treated stabilizing material to the base of a face fabric.

In some embodiments, the method further comprises dissolving or dispersing the antimicrobial compound in an aqueous solution or a volatile organic solvent before applying the antimicrobial compound to the stabilizing material. In some embodiments, the antimicrobial compound is applied to the stabilizing material by submerging the stabilizing material into a fluid comprising the antimicrobial compound or spraying the antimicrobial compound onto the stabilizing material. In certain embodiments, the antimicrobial compound is roll coated onto the stabilizing material. In certain embodiments, the antimicrobial compound is physically incorporated into the stabilizing material or is chemically bonded to the stabilizing material. In some embodiments, the method further comprises drying the pre-treated stabilizing material before attaching the pre-treated stabilizing material to the base of the face fabric.

In some embodiments, the antimicrobial compound comprises zinc pyrithione. In certain embodiments, about 0.5 to about 50 grams of zinc pyrithione are applied per square yard of carpet product and the carpet product exhibits antimicrobial properties sufficient to pass AATCC Test Method 174.

In a preferred embodiment, the antimicrobial compound is first dissolved or dispersed in an aqueous continuous phase, forming a solution or suspension. The stabilizing material 28 is then placed into contact with the aqueous solution or suspension so that the antimicrobial compound is transferred to the stabilizing material 28. For example, the stabilizing material 28 may be submerged into the solution or suspension, for example, using a bath, curtain coating process, or the like. Alternatively, the solution or suspension of the antimicrobial material may be sprayed onto the stabilizing material 28, for example, using a pressurized vessel, pump, and spray nozzle, as known in the art.

In another embodiment, the continuous phase is or includes a non-aqueous fluid. For example, the continuous phase may comprise a volatile organic solvent. A suitable continuous phase may be selected based, for example, on the physical and chemical properties of the antimicrobial compound and the stabilizing material, as well as on the desired process for transferring the antimicrobial compound to the stabilizing material.

The transfer of the antimicrobial material to the stabilizing material can be accomplished by one or more various mechanisms. It may include physical entrapment, chemical bonding, or a combination thereof. Representative examples include absorption of the antimicrobial compound into the stabilizing material, adsorption of the antimicrobial compound onto the stabilizing material, or a reaction between the two components. In one embodiment, the antimicrobial compound is roll coated onto the stabilizing material before the stabilizing material is dried and attached to the carpet.

Following or in conjunction with the transfer of the antimicrobial material to the stabilizing material, the aqueous continuous phase may be removed from the stabilizing material. In one embodiment, after the antimicrobial compound is transferred to the stabilizing material 28, the stabilizing material 28 may then be dried. Various drying equipment known in the art may be used, including but not limited to gas-fired drying ovens, infrared heating sources, forced hot air blowers, and microwave heaters. The purpose of the drying process is to remove the continuous phase from the stabilizing material 28, thereby leaving the antimicrobial agent attached to the stabilizing material 28. Once dried, the stabilizing material 28 may then be laminated to the bottom of the carpet tile 24 and the carpet tile 24 may be cured as part of an automated assembly line process.

The treatment of the stabilizing material 28 with the antimicrobial compound can be accomplished in a number of different ways. For example, the stabilizing material 28 may be treated at a different time or location than the carpet tile production line. Alternatively, the treatment of the stabilizing material 28 may be integrated into the carpet tile production line as another automated production-line stage. In the latter example, an automated drying stage may preferably be employed between the treatment stage and the lamination stage.

Modifications and variations of the methods and devices described herein will be obvious to those skilled in the art from the foregoing detailed description. Such modifications and variations are intended to come within the scope of the appended claims.

I claim:

1. A carpet product comprising:
a face fabric having a top surface and a base; and
a pre-treated stabilizing material attached to the base of the face fabric,
wherein the pre-treated stabilizing material has an antimicrobial compound coated thereonto or physically incorporated therein.

2. The carpet product of claim 1, wherein the antimicrobial compound comprises zinc pyrithione.

3. The carpet product of claim 2, wherein the carpet product comprises about 0.5 to about 50 grams of zinc pyrithione per square yard.

4. The carpet product of claim 3, wherein the carpet product exhibits antimicrobial properties sufficient to pass AATCC Test Method 174.

5. The carpet product of claim 1, wherein the carpet product is a carpet tile.

6. The carpet product of claim 1, wherein the pre-treated stabilizing material comprise a fiberglass scrim, a non-woven PET, polyamide, polypropylene, polyester or a blend thereof.

7. The carpet product of claim 1, wherein the pre-treated stabilizing material is affixed to the fabric face by a polymer backing layer, and wherein the polymer backing layer comprises substantially no antimicrobial compound additive.

8. A carpet product comprising:
a primary carpet base having a fabric face side and an opposed back side;
a polymer backing layer attached to the back side of the primary carpet base; and
a layer of a pre-treated stabilizing material laminated or otherwise attached to the polymer backing layer,
wherein the pre-treated stabilizing material has an antimicrobial compound coated thereonto or physically incorporated therein.

9. The carpet product of claim 8, wherein the antimicrobial compound comprises zinc pyrithione.

10. The carpet product of claim 9, wherein the carpet product comprises about 0.5 to about 50 grams of zinc pyrithione per square yard

11. The carpet product of claim 10, wherein the carpet product exhibits antimicrobial properties sufficient to pass AATCC Test Method 174.

12. The carpet product of claim 8, wherein the carpet product is a carpet tile.

13. The carpet product of claim 8, wherein the pre-treated stabilizing material comprise a fiberglass scrim, a non-woven PET, polyamide, polypropylene, polyester or a blend thereof.

14. The carpet product of claim 8, wherein the polymer backing layer comprises substantially no antimicrobial compound additive.

15. A method of manufacturing a carpet product comprising:
a. applying an antimicrobial compound to a stabilizing material to produce a pre-treated stabilizing material that exhibits antimicrobial properties; and
b. attaching the pre-treated stabilizing material to the base of a face fabric.

16. The method of claim 15, further comprising dissolving or dispersing the antimicrobial compound in an aqueous solution or a volatile organic solvent before applying the antimicrobial compound to the stabilizing material.

17. The method of claim 15, wherein the antimicrobial compound is applied to the stabilizing material by submerging the stabilizing material into a fluid comprising the antimicrobial compound or spraying the antimicrobial compound onto the stabilizing material.

18. The method of claim 15, further comprising drying the pre-treated stabilizing material before attaching the pre-treated stabilizing material to the base of the face fabric.

19. The method of claim 15, wherein the antimicrobial compound is physically incorporated into the stabilizing material or is chemically bonded to the stabilizing material.

20. The method of claim 15, wherein the antimicrobial compound is roll coated onto the stabilizing material.

21. The method of claim 15, wherein the antimicrobial compound comprises zinc pyrithione.

22. The method of claim 21, wherein about 0.5 to about 50 grams of zinc pyrithione are applied per square yard of carpet product.
